(19) United States
(12) Patent Application Publication
(10) Pub. No.: US 2008/0004932 A1
(43) Pub. Date: Jan. 3, 2008

(54) System and method for quantity-related comparison between planning and default data of a technical process or a technical project

(75) Inventors: Peter Beer, Mannheim (DE); Andreas Liefeldt, Lunen (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/797,752

(22) Filed: May 7, 2007

(30) Foreign Application Priority Data
May 8, 2006 (DE) 10 2006 021 540.0

(51) Int. Cl. G05B 19/418

(52) U.S. Cl. 705/8

(57) ABSTRACT

A system and a method are disclosed for automated quantity-related comparison between planning/project and default data of a technical process or a technical project, with an input module for the supply of the default data and a planning tool for storage of the planning data. The input module is provided to transmit the individual elements of the default data as default elements to the planning tool for further processing. The planning tool has a planning module, in which the individual elements of the planning data are stored as planning elements. The planning tool further has an assignment module for generating a mapping of the default elements on to the planning elements. Based on the generated mapping of the default elements on to the planning elements, a processing module integrated in the planning tool automatically performs a quantity-related comparison between the number of planning elements and of default elements, and makes the comparison results available to an evaluation module.

### RELATED APPLICATION

This application claims priority under 35 U.S.C. §119 to German Application 10 2006 021 540.0 filed in Germany on May 8, 2006, the entire contents of which are hereby incorporated by reference in their entireties.

### TECHNICAL FIELD

The disclosure relates to a system and a method for automated quantity-related comparison between planning and default data of a technical process or a technical project.

### BACKGROUND INFORMATION

For the planning of a technical plant, the course of an industrial process or a technical project, subsequently referred to as a process or project, it is necessary to obtain, if possible at any time, an overview of the current status and/or already planned numbers for certain items, such as actuators, sensors, switching cabinets, signals or cable length quantities, in comparison with preset numbers, subsequently also referred to as default data, in order for example to handle both complex capital projects and complex technical processes with an effective utilization of resources within a preset time frame and budget. An indispensable prerequisite for this is clearly structured and informative reporting, in order to be informed at all times about the status of the project or process. The already planned numbers of certain items, such as actuators, sensors, switching cabinets, signals or cable length quantities, are subsequently also referred to as quantifiable items.

Usually in the planning of a technical process or a technical project, the individual items such as a certain motor type are used in very different places in the project. Thus for example the motor type must be allowed for in a certain number by means of a special planning tool, depending on its use. This gives rise to the need to check whether a preset number is exceeded by the already planned number, i.e. a comparison of the preset numbers with the numbers already planned in the project for this item.

So long as the planning of the plant or process is done by one person only, or only a few items are necessary for planning the process, the project can be tracked without major problems.

However, the project tracking in major engineering projects represents a considerable cost, which becomes greater as more persons are involved in the planning of the project or process, and as more items have to be tracked during the planning phase of the project.

Currently, the planned items are entered in an automated operation in the previously described comparison analyses, which give an overview, if possible at any time, of the current status or already planned numbers of certain items. However, a quantity comparison between the planned items and the default data is predominantly manually performed, as described below.

In order to compare the planned quantities with the default data with the help of a planning tool, the data is exported from the planning tool used, and possibly sorted and/or filtered externally. In a second step, the exported and prepared planning data is compared with the external default data. The actual comparison is done either manually with a search for the corresponding data pairs, or with partial tool support using macros from spreadsheet programs. In a third step, the results of the comparison are individually prepared for a report, for example.

The previously described procedure requires several process steps, some of them manual, which are correspondingly time-consuming for larger volumes of data. If several workers or tools are involved in an analysis, the data has to be merged and/or synchronized. These manual process steps imply that this method is not only time-consuming but also error-prone.

### SUMMARY

A system and a method are disclosed for automated quantity-related comparison between planning and default data of a technical process or a technical project, whereby aforementioned disadvantages of prior art can be overcome.

An exemplary system for automated quantity-related comparison between planning/project and default data of a technical process or a technical project includes an input module for the supply of the default data, for example from an offer or a planning document, and a planning tool in which the planning data is stored.

The input module is provided to transmit the individual elements of the default data as default elements to the planning tool for further processing.

The planning tool has a planning module, in which the individual elements of the planning data are stored as planning elements. The planning tool further has an assignment module for generating a mapping of the default elements on to the planning elements.

The various exemplary systems and methods can be used in process planning, system planning or control and instrumentation planning, for a systematic analysis and evaluation of project data by means of the automated quantity-related comparison between the planning and default data. However, it can also be applied in technical planning, as for example in process engineering, plant engineering, system engineering, automation engineering, electrical engineering and cabling.

### BRIEF DESCRIPTION OF THE DRAWINGS

The exemplary embodiments as shown in the following figures are explained and described, along with advantageous developments, improvements and further advantages of the invention. Shown are:

FIG. 1 shows a known manual quantity comparison between planning and default data,

FIG. 2 shows an exemplary embodiment of the system for automated quantity-related comparison between planning/project and default data of a technical process or a technical project,

FIG. 3 shows an example of integrated supplement management,

FIG. 4 shows an example of representation of the results of the comparison, and

FIG. 5 shows an example of a procedural sequence for automated quantity-related comparison between planning/project and default data of a technical process or a technical project.

### DETAILED DESCRIPTION

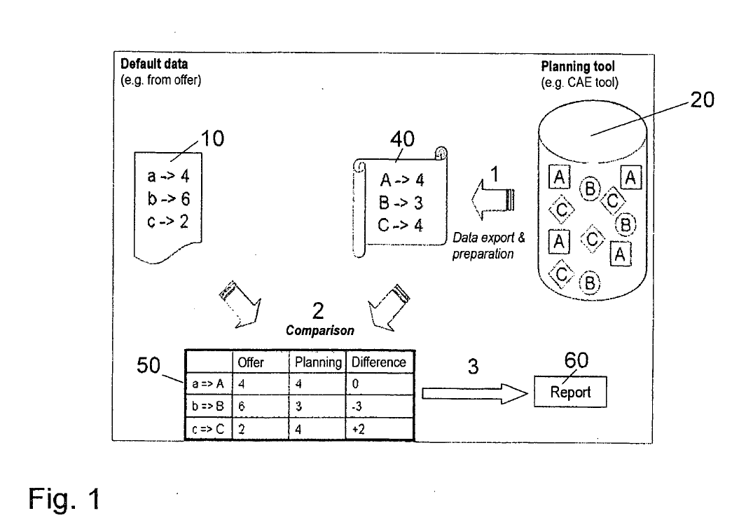

FIG. 1 shows a known manual quantity comparison between planning and default data 10, 40. The offer for a project has 4 of item a. During the planning with a planning tool 20, 4 of the item A is allowed for, and it has to be checked whether the offer number a is exceeded by the planned number A. The comparison analysis described above is not fully automated, the comparison being evaluated by means of a table presentation 50, for example. In order to compare planned quantities or planning data A, B, C, 40 with external quantities or default data a, b, c using the planning tool 20, the planning data A, B, C 40 is therefore in a first step 1 manually or automatically exported from the planning tool 20 used, sorted externally and/or filtered. In a second step 2, the exported and prepared planning data A, B, C, 40 is compared with the external default data a, b, c, 10. The actual comparison is done either manually with a search for the corresponding data pairs, or with partial tool support using standard spreadsheet macros 50. In a third step 3, the results of the comparison are individually prepared for a report 60, for example.

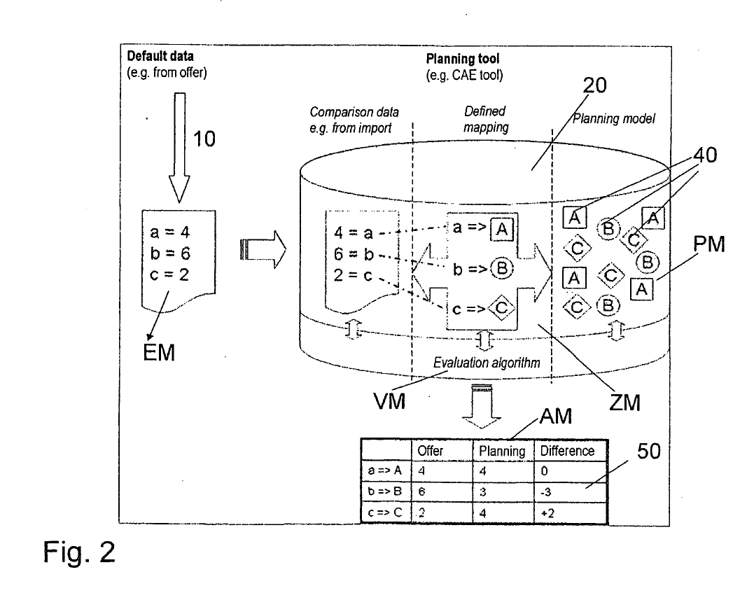

FIG. 2 shows an exemplary embodiment of the system for automated quantity-related comparison between planning/project and default data of a technical process or a technical project with an input module EM for supply of the default data 10 and a planning tool 20 for storing the planning data 40.

The input module EM is provided to transmit the individual elements of the default data 40 as default elements a, b, c to the planning tool 20 for further processing.

The planning tool has a planning module PM, in which the individual elements of the planning data 40 are stored as planning elements A, B, C. The planning tool 20 further includes an assignment module ZM for generating a mapping of the default elements a, b, c on to the planning elements A, B, C.

For the mapping of the default elements a, b, c on to the elements of the planning tool A, B, C, the assignment module ZM allocates a unique identification feature to the elements of the planning tool 20, thus links the elements of the planning tool with external entities, and based on this generates a mapping of the default elements a, b, c on to the planning elements A, B, C.

Based on the generated mapping of the default elements a, b, c on to the planning elements A, B, C, a processing module VM integrated in the planning tool 20 and interacting with the planning tool 20 automatically performs a quantity-related comparison between the number of planning elements A, B, C and the default elements a, b, c, the comparison relating for example to an item number quantity or to quantities with associated properties, and makes the results available to an evaluation module AM.

The evaluation module AM determines the difference between the planning elements A, B, C and the default elements a, b, c, and compares the result of the comparison to the default elements a, b, c, the associated value pairs each consisting of a default element a, b, c and the assigned planning elements A, B, C being linked by means of the identification tag. (Default quantity entity→Identification tag←Number of planning elements).

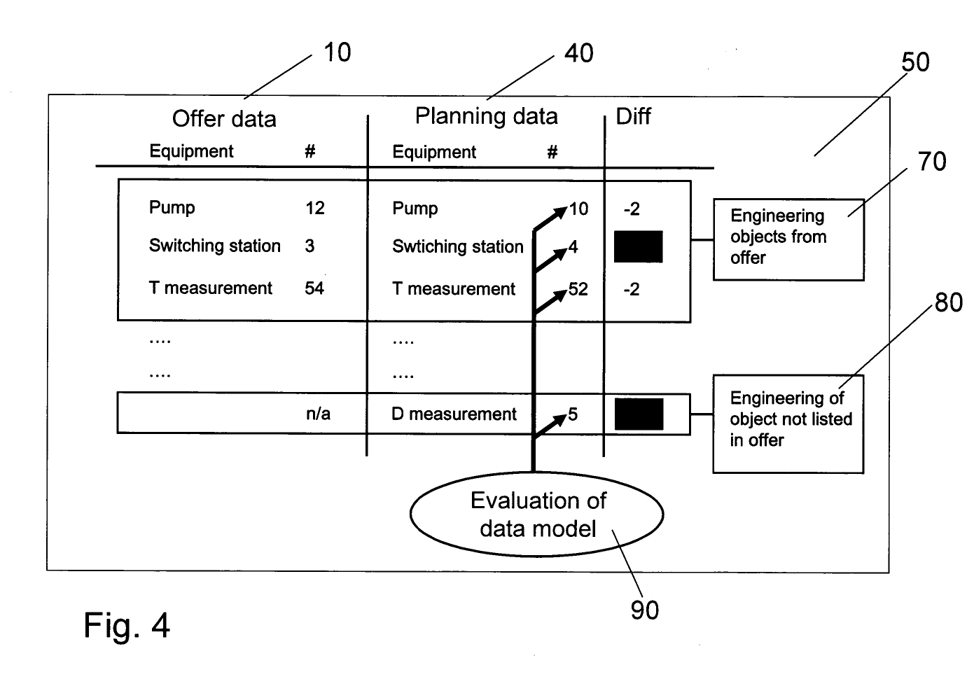

For the presentation of the comparison results supplied by the evaluation module AM, a visualization in a table 50 is provided, for example, as shown in the example of FIG. 4.

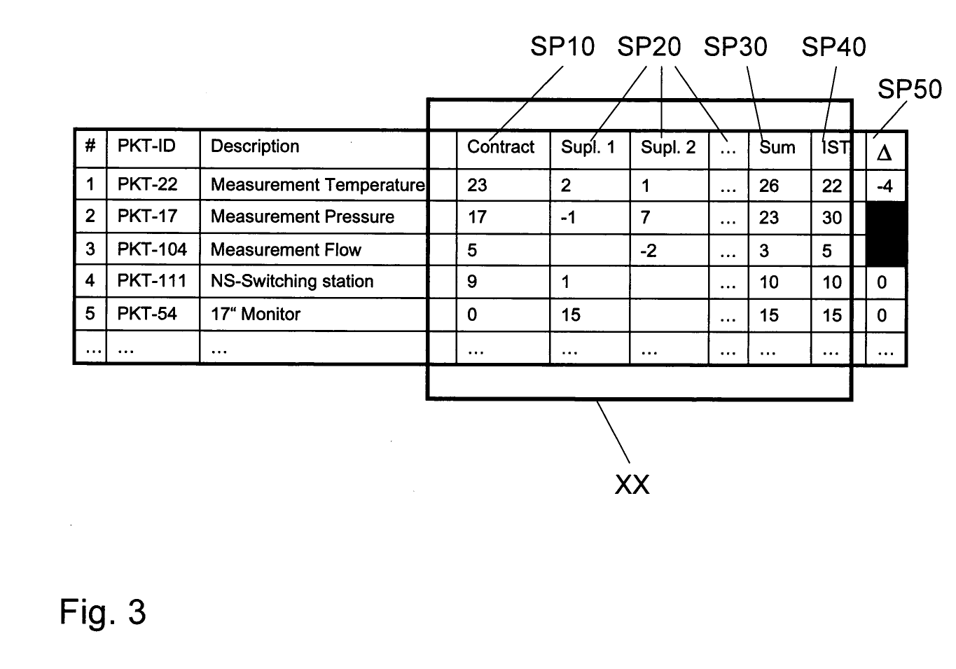

FIG. 3 shows an example of supplement management integrated in the evaluation module. Since the default data 10 entered at the beginning of the project is often subject to changes during the project lifetime, this can be changed. Reasons for changes to the default data 10 include replanning, additional information, or the removal or addition of services to be performed. These changes can be managed either cumulatively or incrementally in the form of supplements. In cumulative management the default data, or default values, is directly overwritten in the case of changes, and only a current default value exists per entity. In incremental supplement management, the increases and reductions are each saved, so that a history is managed at the same time.

The emphasized area XX in FIG. 3 shows a table of quantities of default data SP10 and subsequently entered increases and reductions SP20 including a total SP30. The column SP40 represents the number of corresponding planning elements; the column SP50 shows the difference between the sum of the default elements and the number of the corresponding planning elements.

FIG. 4 shows an example in a table 50 presenting the results of the comparison supplied by the evaluation module, in which the default data 10, the planning data 40, the planned elements from the offer 70 and planned elements 80 which are not listed in the offer, and the evaluation result from the data model 90 are juxtaposed.

The use of a different colour code makes it easier to identify variances to the default data 10 quickly. This visualization can be integrated in the planning tool 20. In a further exemplary embodiment it is provided for the result to be saved as an external file, visualized by means of an external display and output unit, and/or supplied as a paper printout.

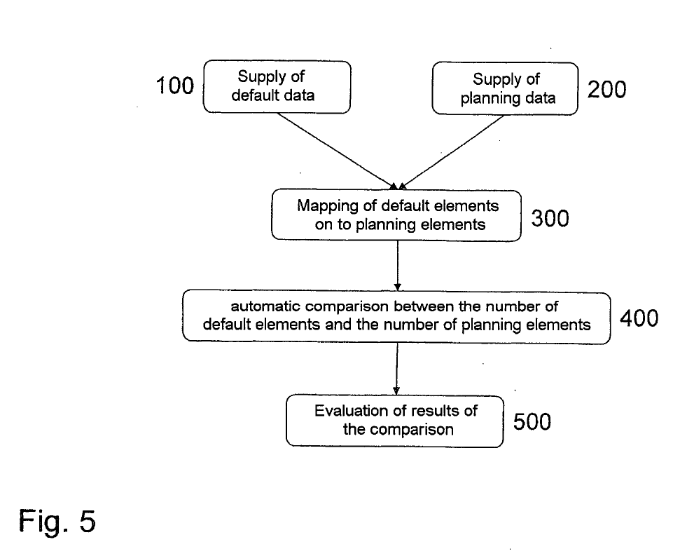

FIG. 5 shows an example of a procedural sequence for automated quantity-related comparison between planning/project and default data of a technical process or a technical project with reference to procedural steps 100-500, the default data such as the quantities of the technical equipment of an offer for a power plant being supplied by an input module, and the planning data such as the design data for the technical equipment of a power plant being stored, generated or changed in a planning tool.

In a first procedural step 100, the individual elements of the default data are supplied as default elements to the planning tool for further processing.

In a second procedural step 200, the individual elements of the planning data are supplied as planning elements by a planning tool, which contains the planning model, for further processing.

In a third step 300, a mapping of the default elements on to the planning elements is generated with an assignment module, and based on the generated mapping of the default elements on to the planning elements, by means of a processing module integrated in the planning tool a quantity-related comparison between the number of planning elements and the number of default elements is automatically performed in a further step 400. The assignment is advantageously stored either in the planning tool or externally, in order that step 300, which with many different planning objects can be very complex, need not be repeated for each project.

In a last step 500, the results of the comparison are transferred to an evaluation module for further processing.

Based on the generated mapping of the default elements on to the planning elements, a processing module integrated in the planning tool automatically performs a quantity-related comparison between the number of planning elements supplied by the planning model and default elements supplied by the input module, and makes the comparison results available to an evaluation module. This quantity-related comparison between the planning and default data relates to quantifiable items, i.e. for example to item numbers and/or quantities with associated properties.

The input of the default data from the offer or planning phase into the planning tool can be effected on the one hand by an automated data import and also on the other hand by manual input, a unique identification feature also being assigned to the default data in addition to the assigned number or quantity. The identification feature comes from the offer or planning phase, or from a tool that was used for offer creation.

In one exemplary embodiment, it is provided that the default data is also managed outside the planning tool, and only read in to the evaluation module for the evaluation in each case.

Since originally entered input data is often subject to changes, it is provided for the default data to be changed and/or adapted throughout the entire planning phase or project lifetime. Changes to the default data are based for example on replanning of the plant or a process, on supplementary or more detailed information after the beginning of planning, or on the removal or addition of services to be performed.

These changes are managed either cumulatively or incrementally in the form of supplements. In cumulative management the default data, also called default values, is directly overwritten in the case of a change, so that only a current default value per item is present. In incremental supplement management, the increases and reductions are each saved, so that a history is managed at the same time.

The assignment module is provided to allocate a corresponding unique identification feature to the elements of the planning tool for the mapping of the default elements on to the planning elements, thus links the planning elements with external entities, and based on this generates a mapping of the respective default elements on to the corresponding planning elements. This identification feature is needed for the identification and assignment of the elements and entities.

An entity describes an external default element, for example from an offer or a planning document, the default element being countable and/or one or more of its properties, such as lengths, being quantifiable. Entities are usually components or product groups, for example a product catalogue device that is mapped in the planning tool as an element. In the ideal case the mapping of the default elements on to the planning elements, subsequently also called mapping, is defined once in the planning tool and merely adjusted at later times within the respective planning or project phase. An adjustment of the mapping is necessary for example when new devices are included in a product catalogue.

The evaluation module is provided to determine the number of planning elements to which a mapping was allocated, these planning elements subsequently also being called converted planning elements. The number of converted planning elements found is compared to the default data, and the connection or link between the planning elements and the default elements through the common unique identification feature can be given in the following representation: “Default quantity entity—Identification tag—Number of planning elements”.

In another exemplary embodiment, a table visualization is provided for the results supplied by the evaluation unit from the comparison between the number of planning elements and the default elements.

An expansion module is optionally provided, which uses an evaluation algorithm to evaluate one or more quantifiable properties of the found elements, such as lengths or volumes, and compares these with the corresponding default data. For this, the mapping is expanded with a first item of information concerning certain properties of the elements, which should be taken into account in the evaluation. The mapping is further expanded with a second item of information, which defines the evaluation and/or determination of the quantity-related comparison between the number of planning elements and the default elements.

For example, if an offer costing of cables of a certain type is made at a flat rate related to the overall length, cables are managed in the planning tool as an element with the property “Length”. After the search for cable elements, the lengths of the cables are added up and the resulting total is compared with the corresponding default from the offer. Assembly hours can also be determined and compared in an identical manner.

An exemplary method for automated quantity-related comparison between planning/project and default data of a technical process or a technical project, is based on a systematic analysis and evaluation of project data by means of an automated quantity-related comparison between the number of elements of a planning tool and the corresponding default data. An automated evaluation can enable the current project status to be determined at any time, independently of the time and the inputs or statements of the workers, so that quantity-related statements can be derived in relation to default data.

The default data is supplied as default elements from an input module and the planning data as planning elements from a planning tool, the default data being generated for example from an offer or a planning document, and the planning data as countable elements and/or modules by the planning tool.

By means of an assignment module, a mapping of the default elements on to the planning elements is generated. In a first step, based on the generated mapping of the default elements on to the planning elements, by means of a processing module integrated in the planning tool a quantity-related comparison between the number of planning elements and of default elements is automatically performed, and the results of the comparison are supplied to an evaluation module.

In a further step, by means of the assignment module a unique identification feature is allocated to each of the planning elements, each of which is linked to external entities, and based on this a mapping of the respective default elements on to the corresponding planning elements is generated. By means of the identification feature a unique identification and assignment of the elements and entities is thus performed.

The exemplary method enables a simple and rapid check of quantity-related variances between the planning of a technical project or a technical process and the defaults set for example in an offer with regard to cost and the time taken for the check.

A further advantage of the described method is based on the early recognition of differences between the planning of the project and the offer, and the corresponding reaction to this.

Unlike an exclusive observation, of the cost side called cost controlling, in which the relationship between the quantities and costs is ignored, which is influenced by purchasing discounts, rough budget costings or erroneous entries, and which blurs the cost view of the underlying quantities, with the exemplary method, which can also be called automated quantity controlling, advantageously supplementing the currently usual tool-supported “cost controlling”, an increased planning reliability is ensured in project handling.

A further advantage of the exemplary method can arise from the consideration of the time factor. Costs can only accrue, and thus be tracked and checked, when they actually accrue through a purchase order and account settlement. The quantities that are converted in the planning of a project are now known much earlier. Thus “quantity controlling” enables an earlier statement about the development of the quantities, and appropriate actions, such as a check of own planning, a check of customer data, a reaction to increases or reductions through changes of delivery quantities from the supplier or a replanning of resources, can be executed correspondingly earlier.

A further advantage can be seen in that possible actions or reactions when default data is exceeded, meaning extra charges to the customer for example, can be initiated in good time. Also if there is a significant shortfall compared to the default data, conclusions can be formed about the respective progress of the project.

A further advantage can be seen in the mass data processing, also called bulk data handling, which enables an efficient evaluation of large quantities of planning elements, which are further distributed over complex structures.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. System for automated quantity-related comparison between planning/project and default data of a technical process or a technical project, with an input module for the supply of the default data and a planning tool for storage of the planning data, wherein
the input module is provided to transmit the individual elements of the default data as default elements to the planning tool for further processing,
the planning tool has a planning module, in which the individual elements of the planning data are stored as planning elements,
the planning tool further has an assignment module for generating a mapping of the default elements on to the planning elements,
based on the generated mapping of the default elements on to the planning elements, a processing module integrated in the planning tool automatically performs a quantity-related comparison between the number of planning elements and of default elements, and makes the comparison results available to an evaluation module.

2. System according to claim 1, wherein the assignment module allocates a unique identification feature to each of the planning elements, links each of them to external entities, and based on this generates a mapping of the respective default elements on to the corresponding planning elements.

3. System according to claim 2, wherein the identification feature is provided for identification and assignment of the elements and entities.

4. System according to claim 1, wherein the generated mapping of the default elements on to the planning elements can be adjusted.

5. System according to claim 1, wherein an offer or a planning document supplies default data.

6. System according to claim 1, wherein the planning tool generates the planning data as countable elements, objects and/or modules.

7. System according to claim 1, wherein the default data is managed outside the planning tool, and can only be read in to the evaluation module for the evaluation in each case.

8. System according to claim 1, wherein the default data can be imported into the planning tool and the corresponding quantities can be saved in the planning tool.

9. System according to claim 1, wherein the evaluation module determines a difference between the planning elements and the default elements.

10. System according to claim 1, wherein the evaluation module compares the result of the comparison to the default elements.

11. System according to claim 1, wherein the quantity-related comparison between the planning and default data relates to item numbers, quantities and/or cumulative quantifiable properties.

12. System according to claim 1, wherein,for the presentation of the comparison result supplied by the evaluation module, a visualization in a table is provided.

13. System according to claim 1, wherein an expansion module is optionally provided, which uses an evaluation algorithm to evaluate one or more quantifiable properties of the found elements, and compares these with the corresponding default data.

14. Method for automated quantity-related comparison between planning/project and default data of a technical process or a technical project, with an input module for the supply of the default data and a planning tool for storage of the planning data, wherein
the individual elements of the default data are supplied as default elements to the planning tool for further processing,
the individual elements of the planning data are supplied as planning elements from a planning model for further processing,
by means of an assignment module, a mapping of the default elements on to the planning elements is generated,
based on the generated mapping of the default elements on to the planning elements, by means of a processing module integrated in the planning tool a quantity-related comparison between the number of planning elements and of default elements is automatically performed, and the results of the comparison are supplied to an evaluation module.

15. Method according to claim 14, wherein a unique identification feature is allocated to each of the planning elements by the assignment module, the planning elements are each linked to external entities, and based on this a mapping of the respective default elements on to the corresponding planning elements is generated.

16. Method according to claim 14, wherein identification and assignment of the elements and entities are executed using the identification feature.

17. Method according to claim 14, wherein the default data is supplied from an offer or a planning document.

18. Method according to claim 14, wherein the planning data is countable elements, objects and/or modules, generated by the planning tool.

19. Method according to claim 14, wherein the default data is managed outside the planning tool, and is only read in to the evaluation module for the evaluation in each case.

20. Method according to claim 14, wherein the default data is imported into the planning tool and the corresponding quantities are saved in the planning tool.

21. Method according to claim 14, wherein by means of the evaluation module a difference is determined between the planning elements and the default elements.

22. Method according to claim 14, wherein the result of the comparison is compared to the default elements.

23. Method according to claim 14, wherein the comparison results supplied by the evaluation module are visualized in a table.

24. Method according to claim 14, wherein, by means of an evaluation algorithm, one or more quantifiable properties of the found elements are evaluated, and these are compared with the corresponding default data.

25. Use of the method according to claim 14 in technical planning, in particular in process engineering, plant engineering, system engineering, automation engineering, electrical engineering or cabling.

26. A method for automated quantity-related comparison between planning/project and default data of a technical process or a technical project, comprising:
supplying individual elements of the default data as default elements to a planning tool for processing;
supplying individual elements of planning data as planning elements from a planning model for processing;
generating a mapping of the default elements on to the planning elements; and
performing a quantity-related comparison between the number of planning elements and the default elements based on the generated mapping of the default elements on to the planning elements, the results of the comparison being used evaluation.
